(19) United States
(12) Patent Application Publication
(10) Pub. No.: US 2015/0197827 A1
(43) Pub. Date: Jul. 16, 2015

(54) METHODS AND SYSTEMS OF METAL SORPTION USING INTERSTAGE SCREENING

(71) Applicant: Derrick Corporation, Buffalo, NY (US)

(72) Inventors: David E. Perkins, South Wales, NY (US); Christian T. Newman, Lakeview, NY (US); James R. Colgrove, Holland, NY (US)

(73) Assignee: DERRICK CORPORATION, Buffalo, NY (US)

(21) Appl. No.: 14/596,016

(22) Filed: Jan. 13, 2015

Related U.S. Application Data
(60) Provisional application No. 61/927,265, filed on Jan. 14, 2014.

(51) Int. Cl. C22B 3/24; B01D 15/02; B01D 33/03; C22B 3/00

(52) U.S. Cl. CPC C22B 3/24; C22B 11/04; B01D 15/02; B01D 33/03

(57) ABSTRACT

Embodiments of the present invention include systems and methods that include a sorption vessel containing a pulp including an aqueous slurry and a sorbent, a screening system at least partially submerged within the pulp and including a housing and a vibratory screening machine including a compression assembly and a screen assembly. The aqueous slurry includes a metal that is adsorbed by the sorbent to form an oversized material in the pulp. The compression assembly compresses the screen assembly into a concave shape and the screen assembly is inclined such that the pulp if fed over a first inclined portion of the screen assembly and the oversized materials are conveyed over a second inclined portion of the screen assembly and removed from the system or conveyed back into the sorption vessel. The undersized material passes through the screen assembly into a portion of the housing separate from the pulp and is discharged to another sorption vessel.

### FIELD

The present invention relates to methods and systems for metal sorption and, in particular though non-limiting embodiments, to an improved system for sorption of gold from a slurry containing ore having a portion of gold using inter-stage screening.

### BACKGROUND

Precious metals (e.g., gold and silver) and other metals (e.g., copper, iron and nickel), are generally contained in ore materials. Metal-containing ores are usually processed in accordance with one or more known techniques so that the metals can be extracted. Common methods of extraction include: carbon-in-pulp, carbon-in-leach, and resin-in-pulp.

Carbon systems involve activated carbon as an adsorbent, usually in the form of activated charcoal, mixed with a slurry of ore in a cyanide solution. In a carbon-in-pulp system, there are mixing tanks for cyanidation leaching prior to the carbon adsorption stage. In contrast, a carbon-in-leach system provides cyanidation in the presence of carbon. Generally, in a resin-in-pulp system, a leached metal-containing ore pulp is exposed to a resin as the adsorbent, typically employed as moderately coarse particles, in a series of agitator tanks. For each of these systems, the adsorbent adsorbs desired metal or precious metal (usually associated as a complex) and is typically separated from the slurry and/or pulp via some type of inter-stage screen assembly. The adsorbent particles are generally larger than the finely ground ore particles, which permits the screening step to be accomplished with relative ease. An overview of sorption methods and systems, including inter-stage screening systems, can be found in Komadina et al. (U.S. Pat. No. 4,933,078) and Komadina et al. (U.S. Pat. No. 4,981,598).

The inter-stage screening assemblies typically utilize a plurality of mechanically or pneumatically agitated tanks arranged in series, usually 4 to 6. Each tank generally contains adsorbent having a different amount of metal adsorbed thereon; with the first tank having the highest and the last tank having the lowest. A slurry of a finely ground ore is introduced into the first tank, while the adsorbent is advanced counter-currently to the flow of slurry from the last tank to the first tank. The slurry is allowed to mix with the adsorbent to form a pulp. The pulp is then agitated to facilitate contact between the mixed adsorbent and slurry, thereby increasing the degree of sorption of metal from the slurry by the adsorbent.

Despite improvements in sorption systems and methods and inter-stage screening, inter-stage screening systems still suffer from low throughput values, high energy costs, and maintenance costs and delays. Accordingly, there is need for improved methods and systems for metal sorption using inter-stage screening providing decreased maintenance downtimes, increased throughput flows, and increased efficiencies.

### SUMMARY

Embodiments of the present invention include a system, including: a sorption vessel containing a pulp including an aqueous slurry and a sorbent; and a screening system at least partially submerged within the pulp and including a housing and a vibratory screening machine including a compression assembly and a screen assembly. The aqueous slurry includes a metal that is adsorbed by the sorbent to form an oversized material in the pulp. The compression assembly compresses the screen assembly into a concave shape and the screen assembly is inclined such that the pulp if fed over a first inclined portion of the screen assembly and the oversized materials are conveyed over a second inclined portion of the screen assembly and removed from the system or conveyed back into the sorption vessel. The undersized material may pass through the screen assembly into a portion of the housing separate from the pulp and is discharged to another sorption vessel.

Embodiments of the present invention include a method of separating a metal containing sorbent from a pulp using a vibratory screening machine. The vibratory screening machine includes a compression assembly that compresses a screen assembly into a concave shape and the screen assembly is inclined such that the pulp if fed over a first inclined portion of the screen assembly and the metal containing sorbet is conveyed over a second inclined portion of the screen assembly.

### BRIEF DESCRIPTION OF THE DRAWINGS

FIG. 1 is a top perspective view of a pair of screening machines, according to an exemplary embodiment of the present invention.

FIG. 2 is a top view, and a close-up view of a portion, of a thermoplastic screen assembly, according to an exemplary embodiment of the present invention.

FIG. 3 is an end internal view of a screening machine and internal thermoplastic screen assembly, according to an exemplary embodiment of the present invention.

FIG. 4 is a side internal view of a screening machine with modified housing, according to an exemplary embodiment of the present invention.

FIG. 5 is a dissected view of a screening machine having a discharge tray, according to an exemplary embodiment of the present invention.

FIG. 6 is an isometric view of a screening machine having a discharge tray, according to an exemplary embodiment of the present invention.

FIG. 7 is a top perspective view of a screening machine having a discharge tray, according to an exemplary embodiment of the present invention.

FIG. 8 illustrates an improved system for metal sorption with parallel vessels, according to an exemplary embodiment of the present invention.

FIG. 9 illustrates an improved system for metal sorption with non-parallel linked vessels, according to an exemplary embodiment of the present invention.

### DETAILED DESCRIPTION

Embodiments of the present invention provide improved methods and systems for sorption of metals from metal-containing ore. Embodiments of the present invention may be utilized with carbon-in-pulp, carbon-in-leach, and resin-in-pulp systems. The general process of recovering gold from a gold bearing ore employing a combined cyanidation and adsorption treatment is described in U.S. Pat. No. 4,188,208, the entire content of which is incorporated herein by reference. While the description in U.S. Pat. No. 4,188,208, relates particularly to gold recovery, embodiments of the present invention may be used in processes for recovering silver, iron, copper, nickel and other metals. The recovery of a metal from a mined ore is within the scope of the present invention.

Methods and systems for sorption of metals using inter-stage screening are provided in Komadina et al. (U.S. Pat. No. 4,933,078) and Komadina et al. (U.S. Pat. No. 4,981,598), both of which are incorporated herein by reference. The present invention provides improvements on the methods and systems disclosed in the Komadina patents. The generally known structures described in the Komadina patents may be implemented with the embodiments of the present invention described herein, including structures and components of the sorption vessels and related systems, as well as process variables and systems. Embodiments of the present invention provide improved methods for sorbing metal values by advancing slurry through a plurality of vessels arranged in series while counter-currently directing a sorbent through the vessels. The slurry may be mixed with the sorbent to form a pulp and portions of the pulp may be subjected to the improved inter-stage screening system to separate adsorbent from the pulp after the adsorbent has adsorbed metal. Portions of the adsorbent may be returned to a particular vessel, portions may be advanced to another vessel in the series, and portions may be separated for processing and/or recovery of metal. The improved inter-stage screening may include improved screening machines partially submerged into the vessels such that the improved screening machines have screening surfaces partially below a predetermined level of pulp in each vessel. The improved inter-stage screening system may include housing for isolating the system from pulp, creating a hydraulic differential between the predetermined pulp level and the screening system.

Embodiments of the present invention may include a plurality of vessels and/or tanks containing improved shaker machines, screens and motors that are designed and configured to work together to provide increased throughput of pulp and/or slurry in a metal sorption process. The improved shaker machines and screens significantly increase efficiency of metal recovery and overall throughput while minimizing maintenance downtime. Improved screening machines may be provided that operate optimally in the tough processing environments common to inter-stage screening systems and allow for quick and efficient maintenance and/or changing out of screen assemblies. Improved screens may be thermoplastic injection molded screens having strength and durability while providing optimal screening area and high throughputs. These improved screens are configured to interface with the improved screening machines for compression mounting and may include various surface configurations for optimizing metal sorption processing. In one embodiment, the screen surfaces have a corrugated or pyramid type shape. The improved screening systems may incorporate one or more improved vibratory motors having a continuous bearing lubrication system that are configured to operate in conjunction with the improved vibratory machines and screens and, when used with these improved apparatuses in the metal sorption process, may provide almost twice the conventional G forces. Embodiments of the present invention also include a discharge tray configured to minimize build-up of adsorbent. Embodiments of the present invention incorporating combinations of the improvements disclosed herein allow for substantially increased flow rates (e.g., machines capable of a flow rates of approximately 800 GPM can be replaced with by machines having flow rates of approximately 2,500 GPM). The improvements disclosed herein may be incorporated and/or retrofitted into existing sorption systems and inter-stage screening assemblies. Embodiments of the present invention allow for additional stages of screening/sorption without increasing space required for vessels and without decreasing total flow rates of an existing sorption system. In certain embodiments of the present invention, existing vessels of a sorption system may be cross-connected to increase absorption rates. The improvements provided herein allow for substantial increases in exposure time between target metals and adsorbent, increasing recovery of the target metal.

Screening of pulp in a counter-current inter-stage screening system can cause substantial wear and tear on screens used for separation of adsorbent from the pulp, requiring frequent screen changes. In order to change screens in traditional screening machines, typically bolts or latching assemblies have to be removed to free the used screen and place in the new screen. Due to the damaging and/or corrosive nature of the pulp being screened, loosening of bolts is often a difficult task and may require that bolts be cut off in order to release the used screen. Because of these difficulties, traditional screening machines can require substantial down time of the entire system in order to change out a screen of a single machine.

In embodiments of the present invention, the improved screening machines provide more efficient screening as well as reduced maintenance costs and time. The improved screens may have a concave support surface between a central member and a wall member with a compression assembly attached to an exterior surface of the wall member. The compression assembly includes retractable members configured to pass through the wall and provide compression against a side of a screen assembly placed in the machine such that the screen assembly is compressed against the central member and into a concave shape supported by the concave support surface. The force from the compression assembly holds the screening assembly in place during high G forces that occur during vibratory screening. Some improved screening machines may have dual, side-by-side screening sections separated by the central member whereas other improved screening machines may have only a single screening section and no central member. Where there is only a single screening section and no central member, the compression assembly compresses the screening assembly against a surface of a second wall opposite the first wall having the compression assembly. Embodiments of the present invention may incorporate screening machines having dual screening sections and screening machines having a single screening section in various combinations throughout the system. Unlike traditional screening machines, the compression assemblies, which are located externally, allow for simple and quick access to release a screen assembly in need of change. Moreover, as the screening machines are partially submerged in the pulp, the compression assembly avoids complications associated with corrosion on other screen locking mechanisms, such as bolts that may need to be cut. To further increase efficiency, the screening machines may include a guide assembly attached to a wall member and having one or more mating surfaces. The guide assembly allows for quick and accurate location of a screen assembly being installed into the machine. Screen assemblies configured to mate with the mating surface can be accurately guided into place without substantial manipulation to correct the location. Incorporation of guides as part of the improved machines further increases efficiencies and decreases down time. The improved screening machines, having increased durability and improved installation options for screen assemblies, also allow for higher excitation forces to be applied to the systems, thereby further increasing screening efficiency and overall efficiency of the system. Embodiments of the system disclosed herein may utilize any combination of vibratory screening machines and different combinations may be employed at different points in the system. In embodiments of the present invention, improved screening machines disclosed in U.S. patent application Ser. Nos. 12/460,200, 13/653,162, and 13/653,014 and U.S. Pat. No. 7,578,394, each of which is incorporated by reference in its entirety, may be incorporated, including the particular screen assemblies described therein, as well as the machines and components and methods for attaching screen assemblies to machines as described therein. The screening machines provided in the present invention include any of the embodiments disclosed in said patent applications.

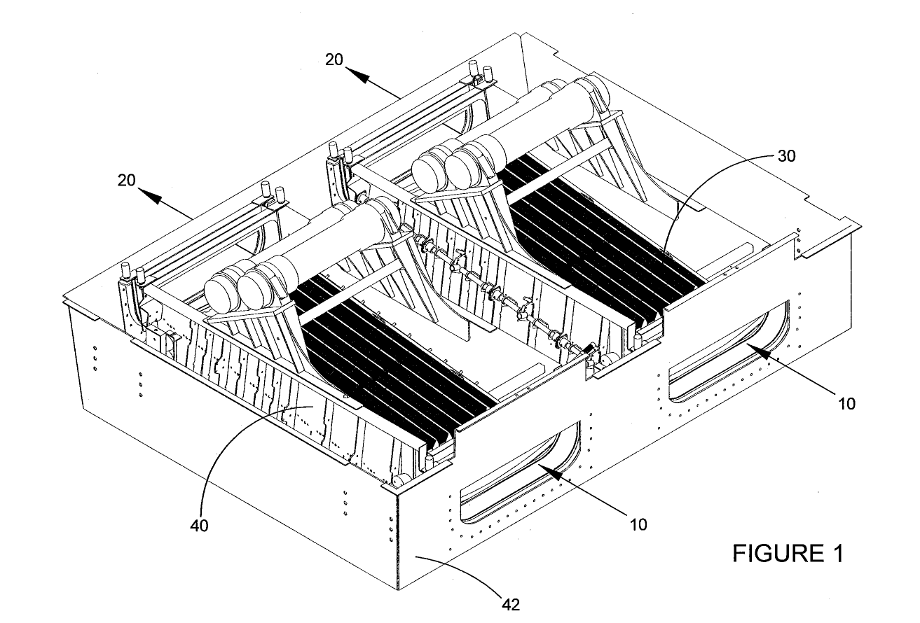

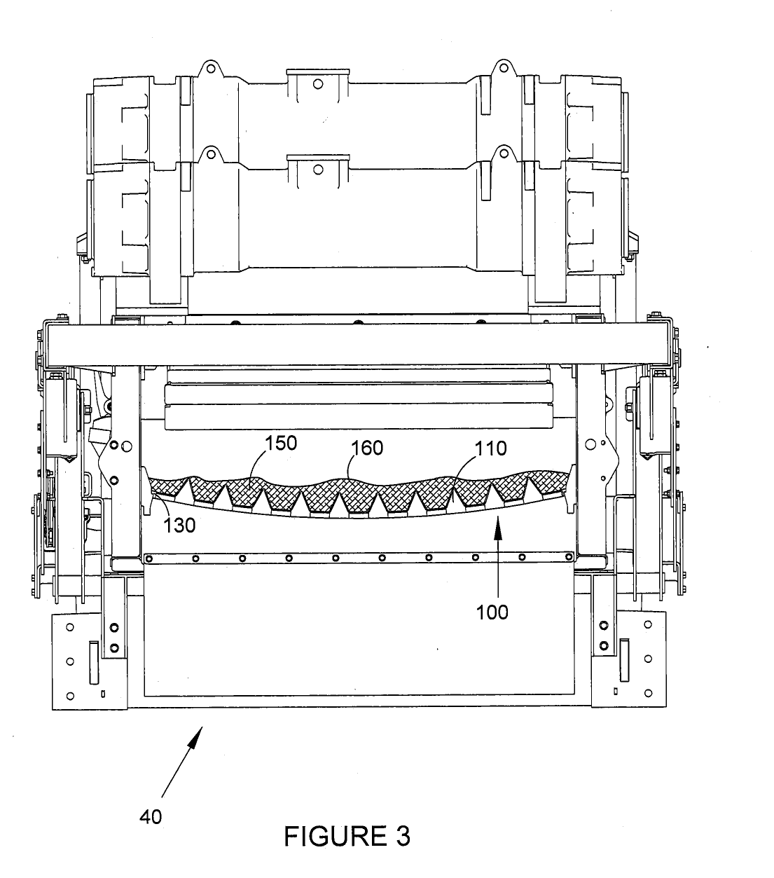

In embodiments of the present invention, screening machines such as provided in FIG. 1 may be included. As shown, a pair of screening machines 40, each having a single screening section, is provided. Alternatively, a single screening machine having two screening sections could be used. Each screening machine includes a compression assembly on an external wall, allowing for the screens to be installed under compression in a concave shape (e.g., FIG. 3), which permits easy removal and installation. Screens may be released from the screening machine by engaging the external compression assembly rather than having to release or cut off a bolt or locking mechanism. The pulp is fed to the screen assemblies 30 via feed sections 10 and recovered adsorbent is discharged via discharge sections 20. When installed in a tank or vessel, a housing 42 is provided such that screening assemblies 30 are angled upward from feed sections 10 to discharge sections 20. The pulp enters via feed sections 10 where non-adsorbent passes through screening assemblies 30 and adsorbent is forwarded through discharge sections 20. Adsorbent may be returned to the vessel or passed forward as provided in U.S. Pat. No. 4,933,078 and U.S. Pat. No. 4,981,598. Ultimately, the adsorbent has a current opposing the current of slurry being added to the system.

Another problem with traditional systems is that the durability of the screens themselves is limited. Due to the nature of the pulp, wire cloth screens are traditionally not utilized in inter-stage vibratory screening systems of the type disclosed herein. Rather, polyurethane screens are typically employed. However, polyurethane screens do not have sufficient durability to withstand long term use in an inter-stage screening system, requiring frequent changes and increasing down time. Additionally, polyurethane screens are generally installed with gripping members to pull the screen over a frame in slightly convex shape and do not typically permit installation via a concave shape under the force of a compression assembly. The screening area for a polyurethane screen is also limited to a flat or slightly convex embodiment.

To overcome the limits of traditional screens, in embodiments of the present invention, thermoplastic injection molded screens and/or screen assemblies may be incorporated. Thermoplastic materials provide excellent flexure and bending fatigue strength and are ideal for use in intermittent or constant heavy loading. The low coefficient of friction of thermoplastic materials provides for optimal wear characteristics, increasing the durability of the screens and screen assemblies. Thermoplastic materials also provide resistance to stress cracking, aging, and extreme weathering. Thermoplastic injection molded screen assemblies may include a number of screen elements having screening openings installed upon a number of subgrids having grid openings, where multiple subgrids are be joined together to form the screen assembly. Each screen element is thermoplastic injection molded and subgrids may be arranged in various combinations to adapt for the intended use of the screen assembly. The screen elements may include reinforcement members as described in U.S. patent application Ser. No. 13/800,826 to increase the strength of the screen elements and retain constant screening openings. Thermoplastic injection molded screen assemblies may be configured to receive a compression force for installation via compression and may be further configured for concave installation. Binder bars may be incorporated into screen assemblies to distribute a compression load across the screen assembly. Additionally, thermoplastic injection molded screen assemblies may incorporate guide mating surfaces configured to mate with a guide assembly of a screening machine having a guide assembly. Accordingly, in the present invention, thermoplastic screen assemblies may be configured for use with any of the improved screening machines. The thermoplastic injection molded screens have an increased screening area over traditional screens used in sorption systems, such as polyurethane screens, allowing for increased flow rates and increased processing of slurry containing metals. Thermoplastic injection molded screens are also substantially resistant to blinding, thereby maintaining a substantially constant effective screening area over the life of the screen. Moreover, thermoplastic molded screens provide for increased durability, efficiency and performance over traditional screens utilized in connection with inter-stage screening systems, allowing for higher vibrational forces to be applied and increased life of the screen assemblies. Additionally, thermoplastic injection molded screen assemblies provide the option of incorporating pyramid shaped subgrids into the screen assemblies. Pyramid shaped subgrids allow for the creation of a corrugated screening surface substantially increasing screening surface areas without using additional screening machines. The increased screening surface area provides increased throughput of the system. Prior to the present invention, attempts to incorporate corrugated screening surfaces into sorption systems failed because the slurry loads on the screens flattened and ripped the screens causing catastrophic failure. The increased strength and durability of thermoplastic injection molded screens allows for corrugated screens to be included in sorption systems thereby increasing effective screening area without increasing size requirements for the system. In embodiments of the present invention, thermoplastic injection molded screens and/or screen assemblies may be incorporated such as the screen assemblies specifically disclosed in U.S. patent application Ser. Nos. 13/800,826 and 14/268,101, the entirety of both of which are incorporated herein by reference.

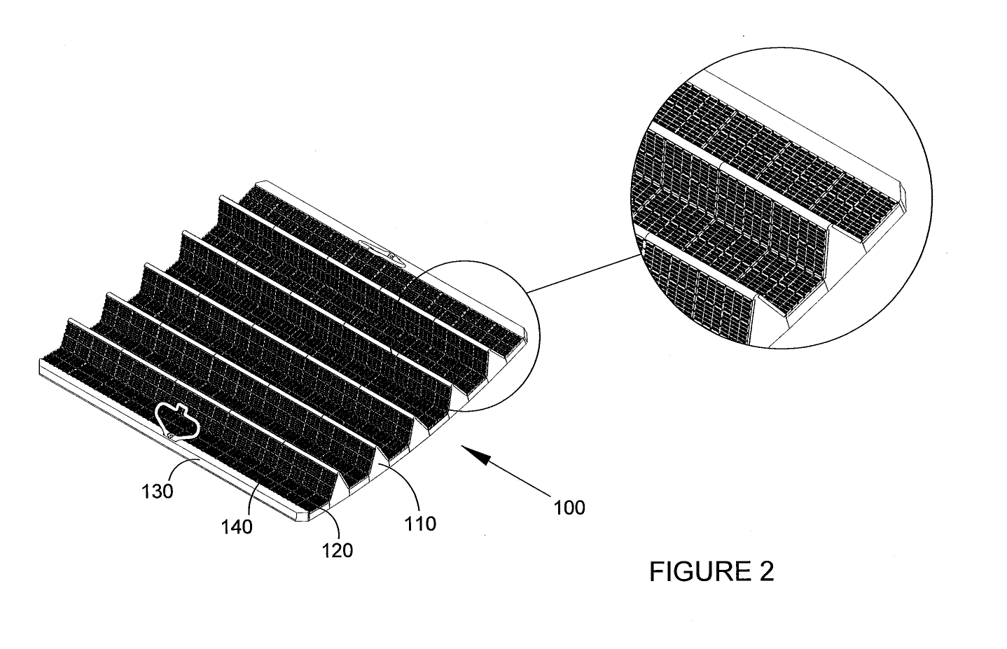

Screen assemblies may include thermoplastic screen assemblies as shown in FIG. 2. Screen assembly 100 includes a plurality of screening members 140 upon a plurality of connected screening frames forming flat portions 120 and pyramid shaped subgrids 110. See also, FIG. 3. Incorporation of pyramid shaped subgrids 110 increases the screening area of screening assembly 100, which in turn increases the potential maximum flow rates though screening assembly 100. Binder bars 130 are also incorporated into the sides of the screening assembly 100 and connected to the walls of the screening machine 40, as seen in FIG. 3. FIG. 3 also illustrates a screening machine 40 being partially submerged into a vessel such that the screening machine 40 has a screening surface partially below a predetermined level 160 of pulp 150 in each vessel.

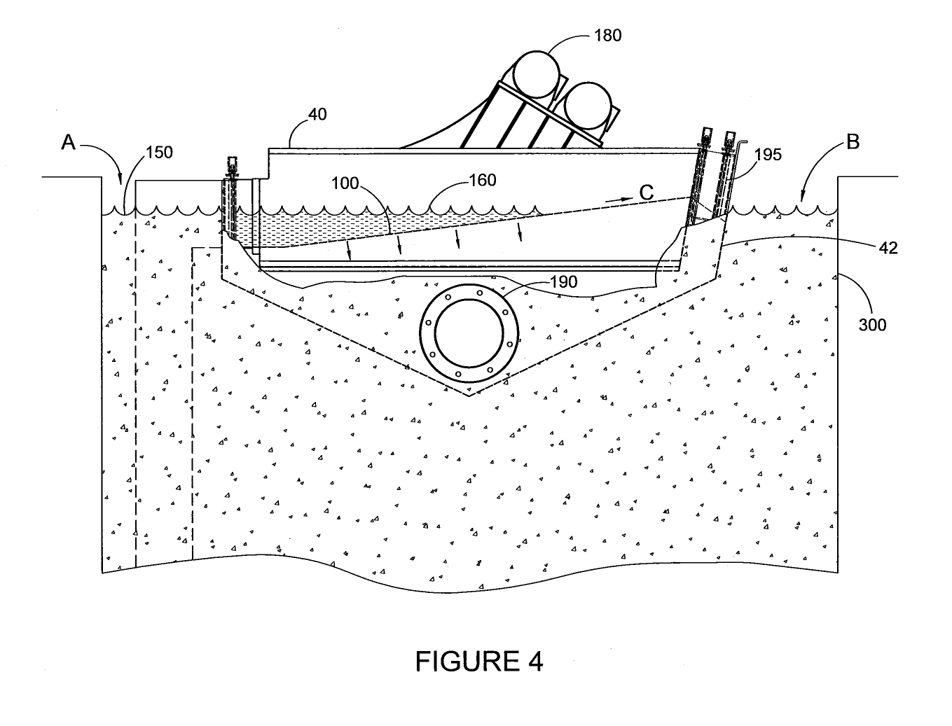

Durability limitations and smaller open screening areas of prior screens and screening machines also limited the forces that could be applied to the screening machines without causing undue wear and tear. With the increased structural strength and more open screening area of the screens utilized in embodiments of the present invention, vibratory forces may be increased, thereby further increasing the processing efficiency and flow rate of processed materials. Embodiments of the present invention may include screening machines with one or more vibratory motors 180 having a self-contained continuous bearing lubrication system such as provided in U.S. Pat. No. 6,580,189, the entirety of which is incorporated herein by reference, and shown in FIG. 4. The improved vibratory motors 180 may increase G-forces placed upon screen assemblies from approximately 4.7 G, in typical systems, to approximately 8.4 G. The increased G-forces decrease screen blinding compared to lower G-forces and substantially increase the ability to screen and separate adsorbent, thereby increasing the flow rates and processing of slurry. Embodiments incorporating the improved screens and screening assemblies 100 are able to withstand substantially higher G-forces. The improved vibratory motors 180 disclosed herein could not be utilized with prior systems, because both the machines and the screens of the older systems would crack, leading to failures.

The increased screening efficiencies and flow rates provided by embodiments of the present invention also lead to increased discharge flow of slurry passing through the screens of the screening assemblies. The increased flow of passed-through materials can lead to backups in traditional screening machines and systems, such as those shown in Komadina et al. (U.S. Pat. No. 4,933,078) and Komadina et al. (U.S. Pat. No. 4,981,598).

According to an example embodiment of the present invention, as shown in FIG. 4, slurry is introduced into a vessel or tank 300 in any conventional manner, but is shown introduced at the locus at arrow A. Similarly, sorbent is concurrently introduced into the vessel or tank 300 in any conventional manner, but is shown introduced at the locus at arrow B. Introduction of both the slurry and the sorbent will create a pulp 150 within the vessel or tank 300. Agitators may be used to mix the slurry and sorbent as described in the Komadina patents. Improved vibratory motors 180 operate at high G-forces (up to approximately 8.4 G) and provide uniform distribution of the pulp on the screening machine and increase flow rates through the screening machine. Continuous introduction of slurry via arrow A along with the continuous introduction of sorbent via arrow B assures the maintenance of the pulp level at a predetermined level 160 of pulp 150. A portion of the pulp 150 is then directed into a screening machine 40 at which point it becomes isolated from the rest of the pulp 150 in the vessel or tank 300. As provided in Komadina et al. (U.S. Pat. No. 4,933,078) and Komadina et al. (U.S. Pat. No. 4,981,598), an example embodiment of the invention may include baffles being used to direct pulp 150 into the screening machine 40. Further, the amount of pulp 150 to be directed onto the screening machine 40 may be regulated using a feed weir, where the feed weir may preclude or permit entry of pulp 150 into the screening machine 40 through a valve or other mechanism.

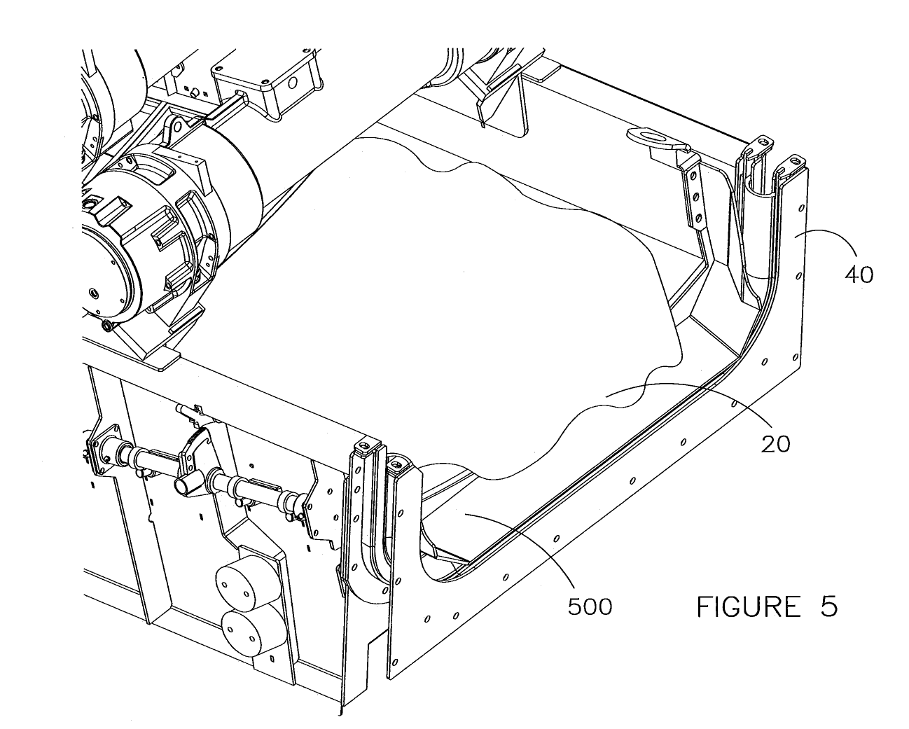

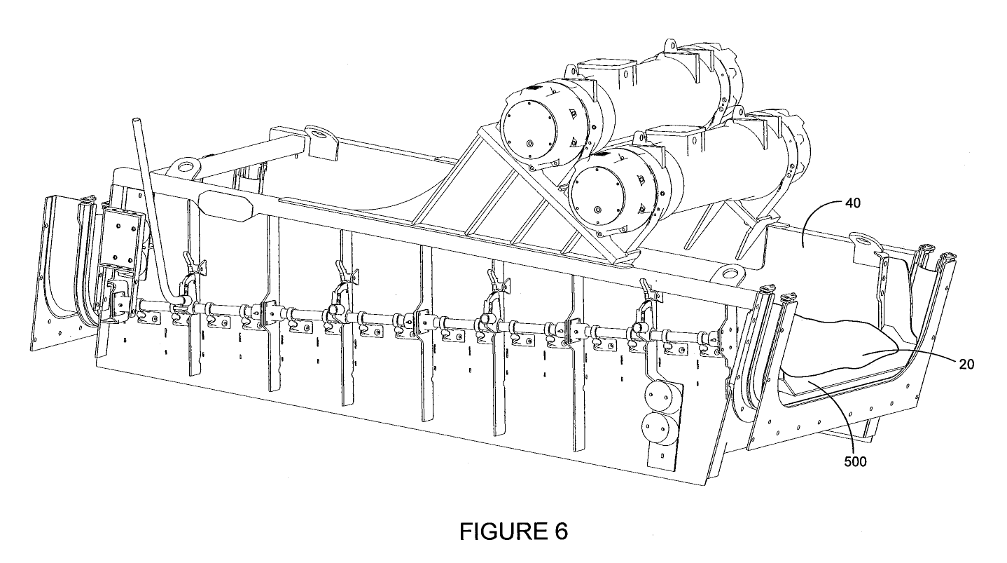

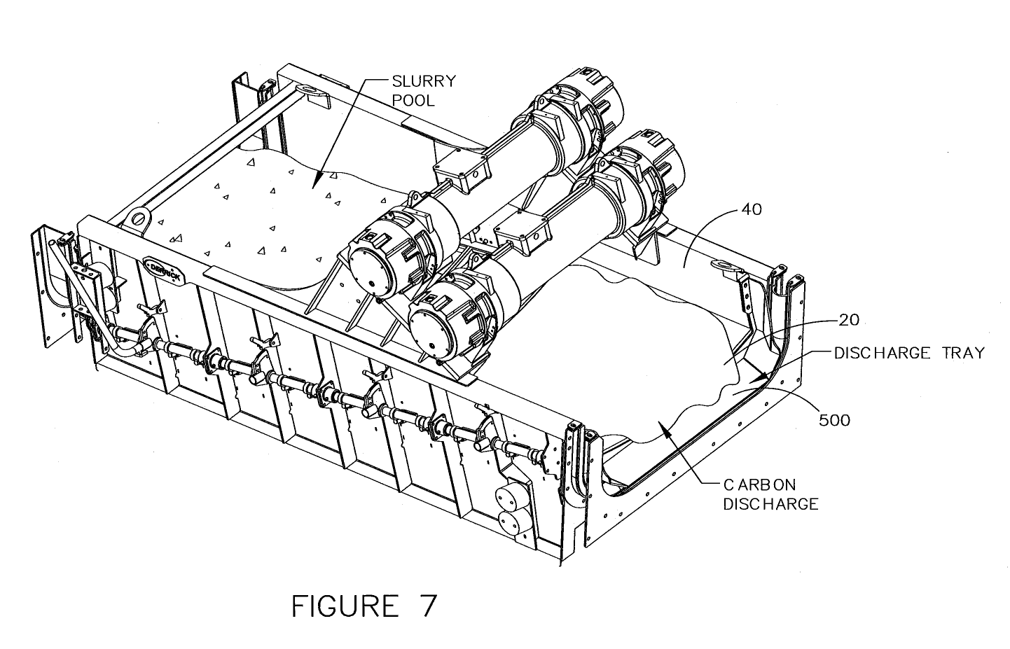

Once the pulp 150 is directed into the screening machine 40, the sorbent (now impregnated with adsorbed metals) is then separated from the slurry and/or pulp 150 by moving upwardly along a screening assembly 100 using vibration from the improved vibratory motors 180. The slurry of the pulp passes through screen openings in the screening assembly 100 while carbon sorbent is retained upon the screen assembly 100. The vibration then urges the sorbent to move upwardly on the screen assembly 100 along arrow C, where it can slide onto a ramp, out discharge 195, and either eventually return back into the pulp 150 in the vessel or tank 300 by the force of gravity or be captured. The ramp may be in the form of a discharge tray 500 that is secured to the vibrating mechanism such that vibrations from the vibratory motors 180 are imparted to the material on the discharge tray 500. See, e.g., FIGS. 5 to 7. Such a configuration prevents buildup and blockages especially for higher flow rate applications.

In an example embodiment of the present invention, the slurry that passed through the screen openings in the screening assembly 100 may accumulate within a modified housing 42 and remain isolated from the pulp in the vessel or tank 300. In an example embodiment of the present invention, the modified housing 42 may angle downward to a discharge pipe 190 to increase efficiency of the slurry discharge. See, e.g., FIG. 4. The discharge pipe 190 may be directed to another downstream vessel or tank. The improved housing and discharge pipe configuration provide for the ability to efficiently discharge slurry at the increased flow rates provided by embodiments of the present invention.

Combining the improved machines, screens, and motors provides for increased screening efficiencies and flow rates, including increased flow of adsorbent to be discharged by the vibratory screening machines. Because of the increased flow of adsorbent to be discharged, build-up of adsorbent and potential blocking of the screening machine may result. Accordingly, as discussed, embodiments of the present invention may incorporate screening machines having discharge trays 500 that may prevent buildup of adsorbent. See, e.g. FIGS. 5 to 7. In exemplary embodiments, discharge tray 500 is attached to screening machine 40 via bolting or some other attachment such that discharge tray 500 is subjected to the vibratory forces of the screening machine. Discharge tray 500 is also angled downward away from the flow of adsorbent. Both the vibration and the angle of discharge tray 500 effectively discharge adsorbent without clogging and/or buildup. Accordingly, discharge flow 20 will flow down discharge tray 500 allowing for continuous screening within screening machine 40.

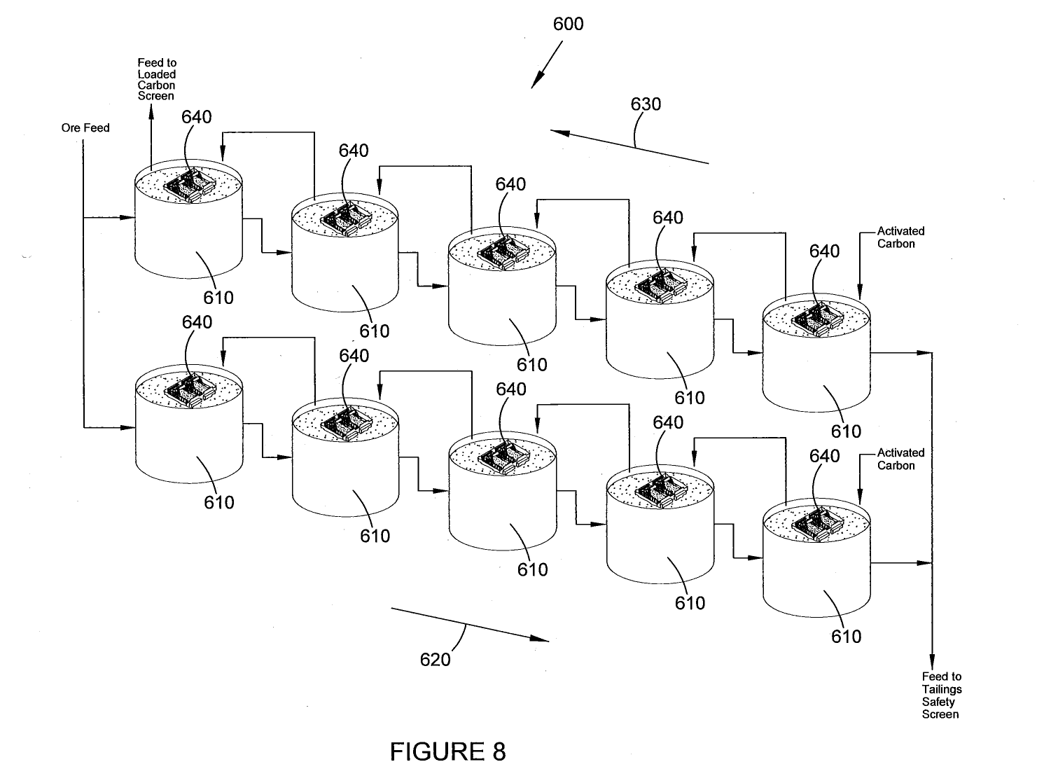

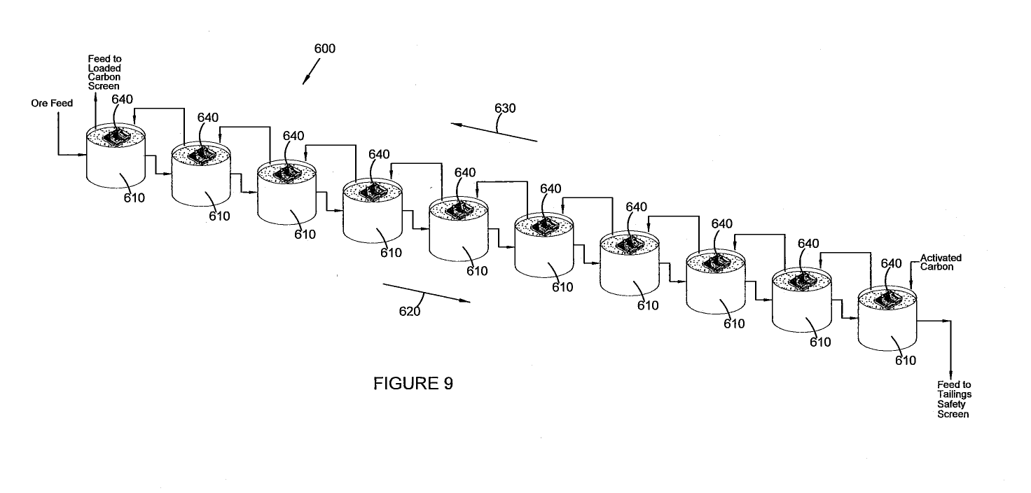

Embodiments of the present invention may allow for retrofitting of an existing sorption system which may increase efficiency, durability and/or recovery of metals. Multiple system configurations may be employed for an inter-stage system, and systems may have one to five or more screening machines per tank. There may be different numbers and/or types of screening machines in different tanks of a single system. In the event that an existing facility has parallel sorption systems running alongside each other, the present invention allows for the systems to be retrofitted in the existing configuration. See, e.g., FIG. 8. Alternatively, the present invention allows for the systems to be linked such that the systems are connected into a single system and the total tanks for a system is significantly increased, and in example embodiments, doubled. See, e.g., FIG. 9. This may be done without reducing the total flow of the original parallel sorption systems. For example, previous systems could have three machines per tank with 800 GPM flow rates per machine and a total recovery of approximately 60%. The machines could be replaced with improved screening machines having flow rates of 2500 GPM, thereby decreasing screening time and increasing exposure between the target metal and the adsorbent. Moreover, the two parallel systems could be interconnected into a single system having 10 tanks and a flow rate in excess of both of the original systems combined, while significantly increasing recovery. In one example embodiment, with 10 tanks in series, the adsorbent is in contact with the target metal twice as long, proportionally increasing recovery. Because of the increased flow rates, additional tanks can be added within existing locations by connecting separate systems. Accordingly, both the recovery rate and overall flow rate of existing systems can be increased with embodiments of the present invention. In embodiments of the present invention, the improvements may be incorporated into existing sorption systems without the need for a redesign or additional space.

FIG. 8 shows an improved system 600 for metal sorption. In this particular embodiment, a system is shown having a pair of parallel systems retrofitted with the new screening machines, screens, and motors disclosed herein. As shown, a plurality of vessels 610 may be arranged in series such that ground ore in aqueous slurry may be introduced at a first end of the series. The aqueous slurry may be mixed with an adsorbent forming a pulp 150. The pulp 150 may be permitted to flow under gravity in direction 620. At an opposite end of the series, an adsorbent, such as activated carbon may be introduced to the system and mixed with the pulp 150. The system may incorporate a plurality of screening machines 640. Screening machines 640 separate adsorbent from the pulp 150 such that the adsorbent may be advanced counter-currently (direction 630) to the flow of pulp 150. Adsorbent may be advanced counter-currently at intervals. For example, carbon advance pumps may be cycled every four hours for one hour at a time. The amount of metal adsorbed by the adsorbent increases in direction 630 until the adsorbent is removed for processing. With the retrofitting, the flow rate of the parallel systems is substantially increased.

Moreover, two existing five tank systems could be linked together. See, e.g., FIG. 9. As shown, the reconfigured tanks include ten total tanks. With double the number of tanks, the exposure time between the adsorbent and the target metal is doubled, proportionally increasing the recovery percentage for the target metal. This may be done while maintaining a flow rate equal to or exceeding the flow rate of both of the original parallel systems together.

Though discussed in connection with the recovery of gold, the present invention may be adapted for the recovery of a variety of precious metals and/or other metals. The present invention may increase the overall effective recovery from ore by increasing the stages of sorption. In turn, the economic viability of a particular deposit may be increased due to the increased recovery rates provided by the present invention. Embodiments of the present invention provide the opportunity to double the number of stages of sorption without increasing the space for a system.

While the embodiments are described with reference to various implementations and exploitations, it will be understood that these embodiments are illustrative and that the scope of the inventions is not limited to them. Many variations, modifications, additions, and improvements are possible.

What is claimed is:

1. A system, comprising:
a sorption vessel containing a pulp including an aqueous slurry and a sorbent; and
a screening system at least partially submerged within the pulp and including a housing and a vibratory screening machine including a compression assembly and a screen assembly,
wherein the aqueous slurry includes a metal that is adsorbed by the sorbent to form an oversized material in the pulp,
wherein the compression assembly compresses the screen assembly into a concave shape and the screen assembly is inclined such that the pulp if fed over a first inclined portion of the screen assembly and the oversized materials are conveyed over a second inclined portion of the screen assembly and removed from the system or conveyed back into the sorption vessel,
wherein undersized material passes through the screen assembly into a portion of the housing separate from the pulp and is discharged to another sorption vessel.

2. The system of claim 1, wherein the aqueous slurry and sorbent are independently fed into the sorption vessel to form the pulp.

3. The system of claim 1, wherein the compression assembly is located on an exterior surface of a side wall of the vibratory screening machine.

4. The system of claim 1, wherein the screen assembly is a thermoplastic injection molded screen assembly.

5. The system of claim 4, wherein the thermoplastic injection molded screen assembly has a corrugated screening surface.

6. The system of claim 4, wherein the thermoplastic injection molded screen assembly has a flat screening surface.

7. The system of claim 4, wherein in the screen assembly includes a binder bar configured to distribute a compression load across the screen assembly.

8. The system of claim 1, wherein the screen assembly includes a mating surface configured to mate with a guide assembly of the vibratory screening machine.

9. The system of claim 1, wherein the vibratory screening machine includes a discharge tray that is vibrated by a vibratory screening motor of the vibratory screening machine.

10. The system of claim 9, wherein the discharge tray includes a member that is angled down and away from the inclined surface of the screen assembly.

11. The system of claim 1, further comprising at least nine addition sorption vessels connected in series with the sorption vessel, the undersized material conveyed to successive sorption vessels, each of the nine additional sorption vessels including the features of the sorption vessel.

12. The system of claim 1, further comprising four additional sorption vessels connected in series with the sorption vessel and five addition sorption vessels in parallel with the same, each of the four additional sorption vessels and five additional sorption vessels including the features of the sorption vessel.

13. The system of claim 1, wherein the vibratory screening machine is operating at approximately 8.4 G and the total material flow rate into and out of the system is approximately 2500 GPM.

14. A method, comprising:
separating a metal containing sorbent from a pulp via a vibratory screening machine, wherein the screening machine includes a compression assembly that compresses a screen assembly into a concave shape and the screen assembly is inclined such that the pulp if fed over a first inclined portion of the screen assembly and the metal containing sorbent is conveyed over a second inclined portion of the screen assembly.

15. The method of claim 14, wherein the compression assembly is located on an exterior surface of a side wall of the vibratory screening machine.

16. The method of claim 14, wherein the screen assembly is a thermoplastic injection molded screen assembly.

17. The method of claim 16, wherein the thermoplastic injection molded screen assembly has a corrugated screening surface.

18. The method of claim 16, wherein the thermoplastic injection molded screen assembly has a flat screening surface.

19. The method of claim 14, wherein the screen assembly includes a mating surface configured to mate with a guide assembly of the vibratory screening machine.

20. The method of claim 14, wherein the vibratory screening machine includes a discharge tray that is vibrated by a vibratory screening motor of the vibratory screening machine.

21. The method of claim 20, wherein the discharge tray includes a portion that is angled down and away from the inclined surface of the screen assembly.

22. The method of claim 14, wherein the vibratory screening machine is operating at approximately 8.4 G and the total material flow rate into and out of the system is approximately 2500 GPM.
